(19) United States
(12) Patent Application Publication
(10) Pub. No.: US 2014/0257826 A1
(43) Pub. Date: Sep. 11, 2014

(54) METHOD AND APPARATUS FOR AUDIO CODING USING CONTEXT DEPENDENT INFORMATION

(71) Applicant: Lasse Juhani Laaksonen, Nokia (FI)

(72) Inventor: Lasse Juhani Laaksonen, Nokia (FI)

(73) Assignee: Nokia Corporation, Espoo (FI)

(21) Appl. No.: 14/352,273

(22) PCT Filed: Oct. 25, 2011
(86) PCT No.: PCT/IB2011/054759

§ 371 Date: Apr. 16, 2014

(51) Int. Cl. G10L 19/00

(52) U.S. Cl. CPC G10L 19/00
USPC 704/500

(57) ABSTRACT

A method comprising determining a first geographical location; processing contextual dependent data to generate a priori information indicative of the quality of a communication channel associated with the first geographical location, wherein the contextual dependent data comprises at least one communication channel quality measure relating to the first geographical location; determining a codec function signal dependent on the a priori information indicative of the quality of the communication channel associated with the first geographical location; and encoding an audio signal according to the determined codec function signal.

### FIELD OF THE APPLICATION

The present application relates to coding, and in particular, but not exclusively to speech or audio coding.

### BACKGROUND OF THE APPLICATION

Audio signals, like speech, are encoded for example to enable efficient transmission or storage of the audio signals.

Speech and audio codecs can be arranged to encode speech signals for efficient transmission over both circuit switched mobile radio systems such as the Global System for Mobile Communications (GSM) and the like, and packet switched networks such as those deploying the Internet protocol (IP) and the like.

Some speech and audio codecs can support a number of different coding rates. These speech and audio codecs are typically known as multi rate speech and audio codecs.

Multi rate codecs can be combined with a forward error correction (FEC) scheme operating at any one of a number of different FEC coding rates.

The source coding rate and error control coding rate can be adjusted to suit the error conditions of a fixed bandwidth communication channel. For example, The Third Generation Partnership Project (3GPP) speech coding standard TS 26.090 Adaptive Multi-rate (AMR) Speech Codec is capable of supporting up to eight operating bit rates varying between 4.75 and 12.2 kbps. The corresponding FEC coding rate can vary from 3.65 kbps to 10.6 kbps.

Each FEC coding rate can be tied to a particular source coding rate, so that when a particular mode of operation is determined the source codding rate and error control rate can be selected as a pair. This has the advantage of maintaining a constant bandwidth across different operating conditions of the transmission channel.

Having a mechanism which allows the source coding rate to decrease and the FEC coding rate to increase can result in an overall improvement in the speech quality over a poor quality transmission channel.

However, such systems may be considered to be reactive in nature in that a change in channel conditions is required to be first detected before there is a corresponding responsive change in the source and FEC coding rates. In some operating conditions this reactive approach can result in lower speech quality.

### SUMMARY OF EMBODIMENTS

This application proceeds from the consideration that speech and audio coding systems, including multi rate speech coding systems typically employ a reactionary approach in determining parameters such as the optimum source and FEC coding rates for a particular transmission channel. Whilst this approach can lead to a general improvement in speech quality there can exist particular transmission channel conditions in which the reactionary approach does not lead to optimum speech quality.

The following embodiments aim to address the above problem.

According to an aspect, there is provided a method comprising determining a first geographical location; processing contextual dependent data to generate a priori information indicative of the quality of a communication channel associated with the first geographical location, wherein the contextual dependent data comprises at least one communication channel quality measure relating to the first geographical location; determining a codec function signal dependent on the a priori information indicative of the quality of the communication channel associated with the first geographical location; and encoding an audio signal according to the determined codec function signal.

The codec function signal may be indicative of at least one of: a source coding rate; a source coding mode; and a forward error correction coding rate.

The method may further comprise at least one of: receiving the contextual dependent data from a contextual dependent data server; and receiving the contextual dependent data from a mobile device.

The method may further comprise: generating contextual dependent data for the first geographical location by measuring the error of the at least one communication channel to determine the at least one communication channel quality measure relating to the first geographic location.

The at least one communication channel quality measure may be a bit error rate of the at least one communication channel.

The at least one communication channel quality measure may be a frame error rate of the at least one communication channel.

The method may further comprise: transmitting the contextual dependent data to at least one of: a mobile device; and the contextual dependent data server.

The coding function signal may indicate a source coding mode the audio signal is encoded using a multimode audio codec.

The coding function signal may indicate a source coding rate the audio signal is encoded using a multi rate audio codec.

The first geographical location may be in the form of global positioning system coordinates.

According to another aspect, there is provided a method comprising receiving contextual dependent data from at least one mobile device, wherein the contextual dependent data comprises at least one communication channel quality measure relating to a geographical location of the at least one mobile device and information relating to the geographical location of the at least one mobile device; processing contextual dependent data from the at least one mobile device to determine an averaged contextual dependent data for the geographical location; and
transmitting the averaged contextual dependent data from the at least one mobile device to a further mobile device, wherein the transmission of the averaged contextual dependent data is dependent on the further mobile device being in the geographical location.

The method may further comprise: receiving data from the further mobile device, wherein the received data indicates that the further mobile device is in the geographical location.

The geographical location may be in the form of global positioning system coordinates.

According to a further aspect, there is provided an apparatus comprising at least one processor and at least one memory including computer code for one or more programs, the at least one memory and the computer code configured to with the at least one processor cause the apparatus to at least perform: determining a first geographical location; processing contextual dependent data to generate a priori information indicative of the quality of a communication channel associated with the first geographical location, wherein the contextual dependent data comprises at least one communication channel quality measure relating to the first geographical location; determining a codec function signal dependent on the a priori information indicative of the quality of the communication channel associated with the first geographical location; and encoding an audio signal according to the determined codec function signal.

The codec function signal may be indicative of at least one of: a source coding rate; a source coding mode; and a forward error correction coding rate.

The at least one memory and the computer code configured with the at least one processor may cause the apparatus to at least further perform at least one of: receiving the contextual dependent data from a contextual dependent data server; and receiving the contextual dependent data from a mobile device.

The apparatus may be further caused to perform at least one of: generating contextual dependent data for the first geographical location by measuring the error of the at least one communication channel to determine the at least one communication channel quality measure relating to the first geographic location.

The at least one communication channel quality measure may be a bit error rate of the at least one communication channel.

The at least one communication channel quality measure may be a frame error rate of the at least one communication channel.

The apparatus may be further caused to perform: transmitting the contextual dependent data to at least one of: a mobile device; and the contextual dependent data server.

The coding function signal may indicate a source coding mode the audio signal is encoded using a multimode audio codec.

The coding function signal may indicate a source coding rate the audio signal is encoded using a multi rate audio codec.

The first geographical location may be in the form of global positioning system coordinates.

According to a further aspect, there is provided an apparatus comprising at least one processor and at least one memory including computer code for one or more programs, the at least one memory and the computer code configured to with the at least one processor cause the apparatus to at least perform: receiving contextual dependent data from at least one mobile device, wherein the contextual dependent data comprises at least one communication channel quality measure relating to a geographical location of the at least one mobile device and information relating to the geographical location of the at least one mobile device; processing contextual dependent data from the at least one mobile device to determine an averaged contextual dependent data for the geographical location; and transmitting the averaged contextual dependent data from the at least one mobile device to a further mobile device, wherein the transmission of the averaged contextual dependent data is dependent on the further mobile device being in the geographical location.

The apparatus may be further caused to perform: receiving data from the further mobile device, wherein the received data indicates that the further mobile device is in the geographical location.

The geographical location may be in the form of global positioning system coordinates.

According to a further aspect, there is provided an apparatus comprising means for determining a first geographical location; means for processing contextual dependent data to generate a priori information indicative of the quality of a communication channel associated with the first geographical location, wherein the contextual dependent data comprises at least one communication channel quality measure relating to the first geographical location; means for determining a codec function signal dependent on the a priori information indicative of the quality of the communication channel associated with the first geographical location; and means for encoding an audio signal according to the determined codec function signal.

The codec function signal may be indicative of at least one of: a source coding rate; a source coding mode; and a forward error correction coding rate.

The apparatus may further comprise at least one of: means for receiving the contextual dependent data from a contextual dependent data server; and means for receiving the contextual dependent data from a mobile device.

The apparatus may further comprise: means for generating contextual dependent data for the first geographical location by measuring the error of the at least one communication channel to determine the at least one communication channel quality measure relating to the geographic location.

The at least one communication channel quality measure may be a bit error rate of the at least one communication channel.

The at least one communication channel quality measure may be a frame error rate of the at least one communication channel.

The apparatus may further comprise: means for transmitting the contextual dependent data to at least one of: a mobile device; and the contextual dependent data server.

The coding function signal may indicate a source coding mode the audio signal is encoded using a multimode audio codec.

The coding function signal may indicate a source coding rate the audio signal is encoded using a multi rate audio codec.

The first geographical location may be in the form of global positioning system coordinates.

According to a further aspect, there is provided an apparatus comprising means for receiving contextual dependent data from at least one mobile device, wherein the contextual dependent data comprises at least one communication channel quality measure relating to a geographical location of the at least one mobile device and information relating to the geographical location of the at least one mobile device; means for processing contextual dependent data from the at least one mobile device to determine an averaged contextual dependent data for the geographical location; and means for transmitting the averaged contextual dependent data from the at least one mobile device to a further mobile device, wherein the transmission of the averaged contextual dependent data is dependent on the further mobile device being in the geographical location.

The apparatus may further comprise: means for receiving data from the further mobile device, wherein the received data indicates that the further mobile device is in the geographical location.

The geographical location may be in the form of global positioning system coordinates.

A computer program product stored on a medium may cause an apparatus to perform the method as discussed herein.

An electronic device may comprise apparatus as discussed herein.

A chipset may comprise apparatus as discussed herein.

### BRIEF DESCRIPTION OF DRAWINGS

For better understanding of the present invention, reference will now be made by way of example to the accompanying drawings in which:

FIG. 1 shows schematically an apparatus suitable for employing some embodiments;

FIG. 2 shows schematically a multi rate speech/audio codec system suitable for employing some embodiments;

FIG. 3 shows schematically a deployment of the contextual data server and mobile devices according to some embodiments;

FIG. 4 shows schematically a mobile device according to some embodiments; and

FIG. 5 shows a flow diagram of the operation of a mobile device according to some embodiments.

### DESCRIPTION OF SOME EXAMPLE EMBODIMENTS

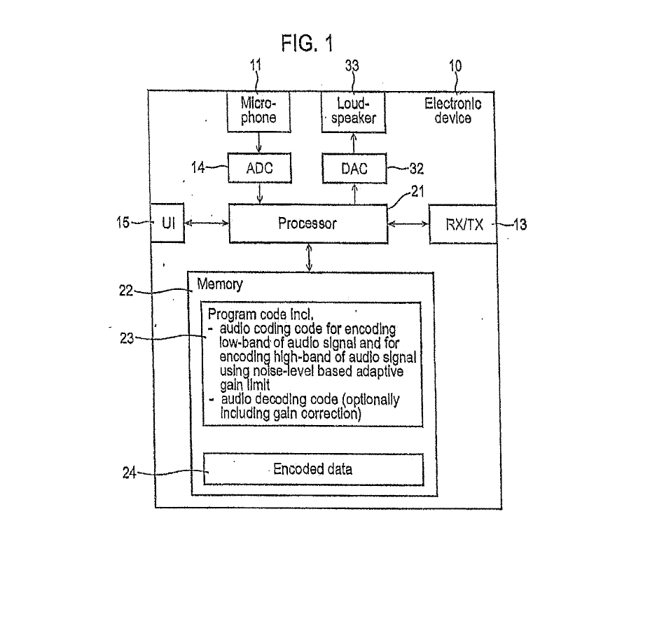

The following describes in more detail possible mechanisms for the provision of determining optimum source and FEC coding rates for a multi rate speech/audio codec, and determining an optimum coding mode selection for a multi coding mode speech/audio codec. In this regard reference is first made to FIG. 1 which shows a schematic block diagram of an exemplary electronic device or apparatus 10, which may incorporate the multi rate speech and audio coding system according to embodiments of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio or speech signals.

The apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 may be configured to execute various program codes. The implemented program codes 23 in some embodiments comprise a multi rate speech codec and a FEC coder which are configured to operate together over a plethora of different source and FEC coding rates. In other embodiments, the implemented program codec 23 may comprise a multimode speech/audio codec which may be configured to operate over a series of different signal types.

In addition the implemented program codes 23 can also comprise coding rate determining code which facilitates the selection of the source coding rate of the multi rate speech and audio codec and the FEC coding rate of the FEC coder. Further, the implemented program codes 23 may also comprise coding mode determining code which can enable the selection of a particular mode of coding of a multimode speech/audio codec.

The implemented program codes 23 can in some embodiments be stored for example in the memory 22 for retrieval by the processor 21 whenever needed. The memory 22 could further provide a section 24 for storing data, for example data that has been encoded in accordance with embodiments of the application.

The components of the multi rate speech and audio codec, FEC coder and coding rate determining code can be implemented in embodiments in either hardware or firmware.

Further, the components of a multimode speech/audio codec and coding mode determining code can also be implemented in embodiments in either hardware or firmware.

The user interface 15 enables a user to input commands to the apparatus 10, for example via a keypad, and/or to obtain information from the apparatus 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

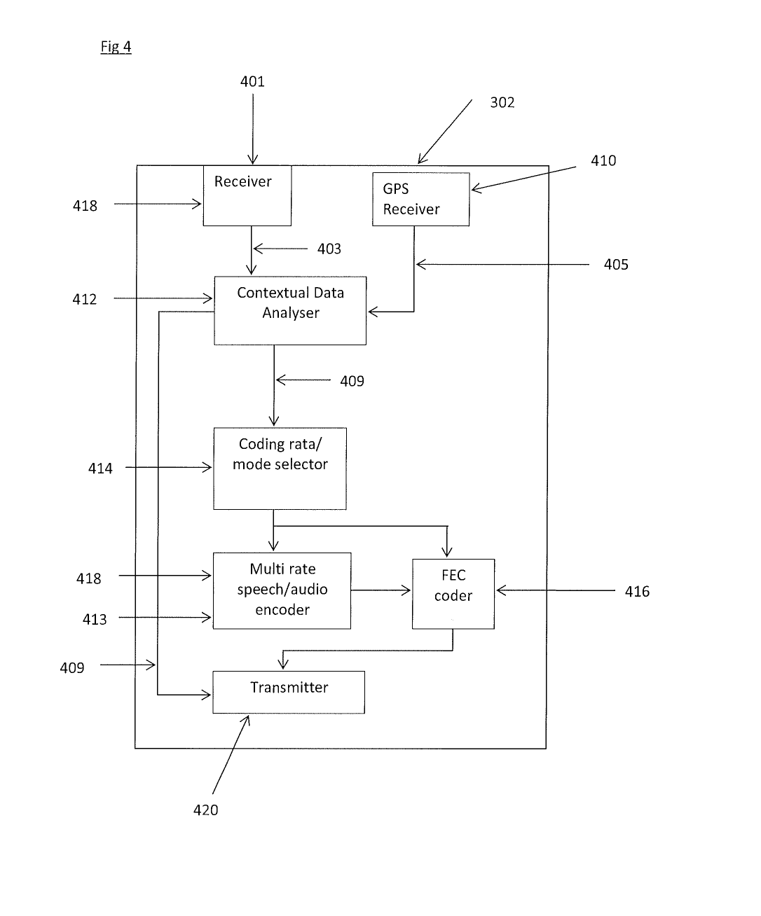

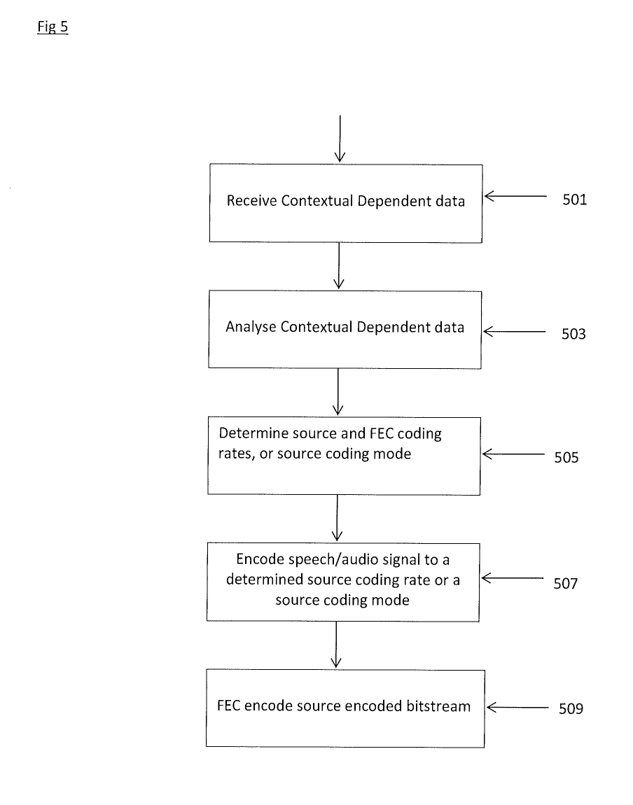

The processor 21 in such embodiments then can process the digital audio signal in the same way as described with reference to FIGS. 4 and 5.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiments can also be stored instead of an immediate presentation via the loudspeakers 33 in the data section 24 of the memory 22, for instance for later decoding and presentation or decoding and forwarding to still another apparatus.

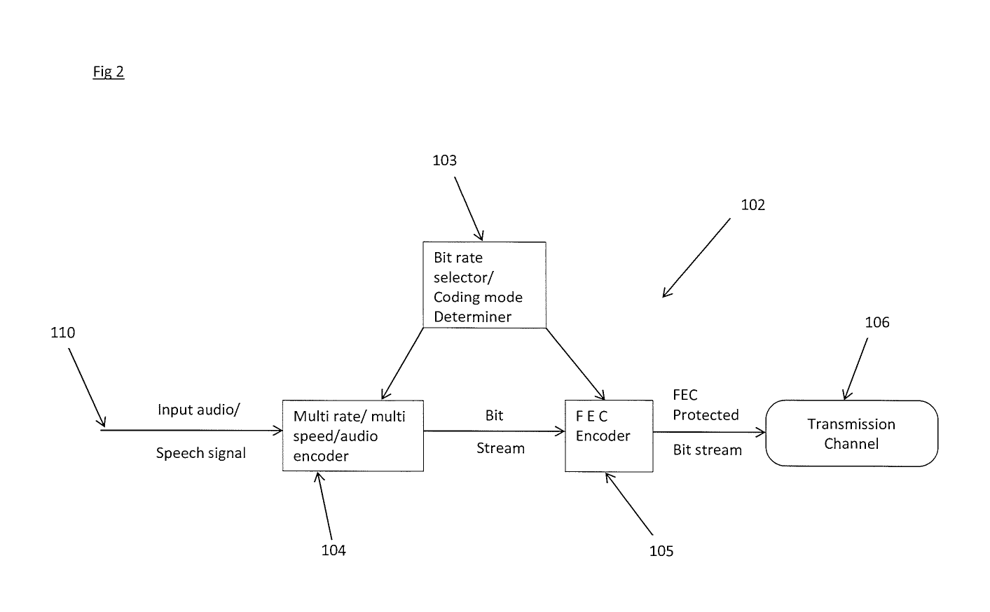

It would be appreciated that the schematic structures described in FIGS. 2 to 4 and the method steps shown in FIG. 5 represent only a part of the operation of embodiments as exemplarily shown implemented in the apparatus shown in FIG. 1.

The general operation of embodiments of the application is shown in FIG. 2. There is illustrated in FIG. 2 a system 102 with a multi rate speech/audio encoder 104, an FEC encoder 105, a bit rate selector 103, and a transmission channel 106. It would be understood that as described above some embodiments of the apparatus 10 can comprise or implement any or all of the source encoder 104, FEC encoder 105 and bit rate selector 103.

The encoder 104 compresses an input audio or speech signal 110 producing a bit stream 112, which in some embodiments can be passed to an FEC encoder 105 for the addition of forward error control (FEC) bits to the bit stream 112. The FEC protected bit stream 113 may then be transmitted through the transmission channel 106.

It is to be appreciated other embodiments may be generally depicted as having a multi rate audio/speech encoder 104 and a coding mode determiner 103. These embodiments may also deploy FEC coding 105.

It is to be further understood in embodiments that a multimode speech/audio codec may refer to a speech/audio codec which can be capable of deploying different modes of source coding whilst coding an audio/speech signal. For instance, a multimode speech/audio codec can comprise a plurality of different source coding algorithms which may each be deployed during the course of encoding the audio/speech signal. In some embodiments each mode of operation may be realised by a particular source coding algorithm.

The deployment of a mode of operation of a multimode source codec may be performed on a frame by frame basis. In other words the mode of operation may change from one frame to the next.

In some embodiments of the multimode source codec an algorithm corresponding to a particular mode of operation may be tailored to suit a particular source signal type. For example a particular algorithm may be tailored to coding a music signal, where as another algorithm may be more particularly suited to coding a speech like signal.

Further examples of multimode source coding algorithms may include algorithms more particularly suited for communication channel conditions in which the channel error rate may be determined to be high. These algorithms may be more robust to communication channel errors.

Other examples of multimode source coding algorithms may include comfort noise generation during regions of silence whilst the multimode source codec operates in a discontinuous transmission (DTX) mode of operation.

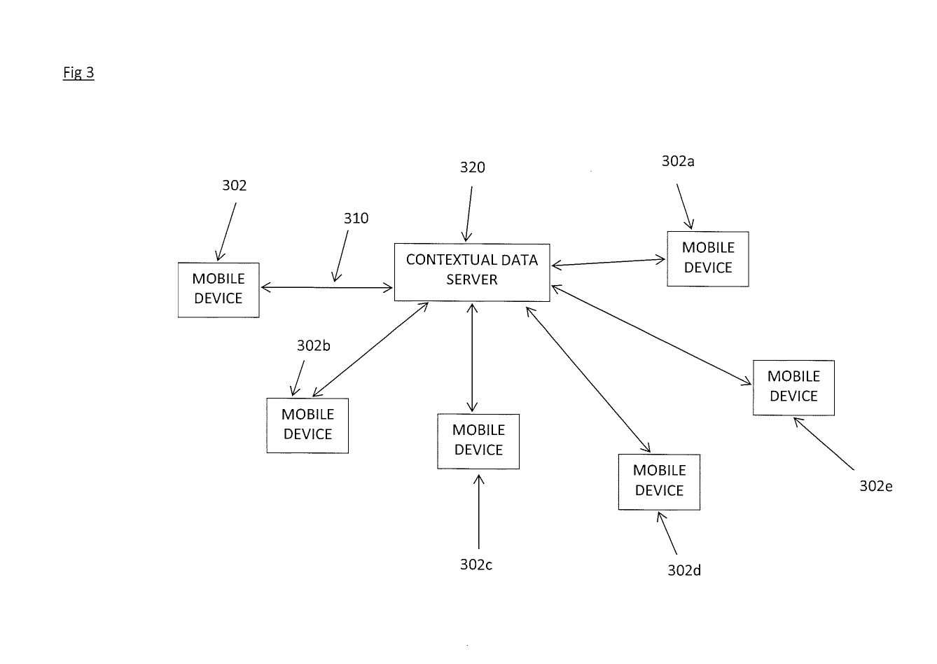

FIG. 3 shows schematically a mobile device 302 according to some embodiments. The mobile device 302 may be arranged in some embodiments to have the form of the user apparatus 10.

The mobile device 302 is depicted as being arranged to receive an input from a contextual data server 320. In some embodiments the contextual data server 320 may be located remotely from the mobile device 302 as depicted in FIG. 3. In these embodiments the mobile device may communicate with the contextual data server 320 via a bi directional wireless data connection, such as for example a GSM GPRS data link, a 3GPP data link or a WLAN link or the like.

The wireless data connection between the contextual data server 320 and the mobile device 302 is depicted as the link 310 in FIG. 3.

In embodiments the contextual data server 320 provides contextual dependent data to the mobile device 302. The contextual dependent data may assist the mobile device 302 in selecting an appropriate source and FEC coding rates for the forthcoming communication channel.

In other embodiments contextual dependent data as provided by the contextual data server 320 may also assist the mobile device 302 in selecting the appropriate coding mode for the forthcoming communication channel.

In some embodiments the contextual data server 320 may be aware of the location of the mobile device 302. In such embodiments contextual dependent data provided to the mobile device 302 may be tailored for its geographical location.

The contextual data server 320 may obtain geographical knowledge of the mobile device 302 by either the mobile device 302 sending Global Positioning System (GPS) coordinate data to the contextual data server 320 over the wireless data link 310, or by the contextual data server 320 obtaining cell location data from the cell within which the mobile device 302 is currently active.

In some embodiments the contextual dependent data provided by the contextual data server 320 may comprise error information such as frame error rates, bit error rates, or other parametric indicators which indicate the noise or quality of a communication channel.

It is to be understood in embodiments that the context data server 320 may provide contextual data relevant for the geographical location or cell location in which the mobile device 302 is currently active.

The contextual dependent data may then be used by the mobile device 302 to select a particular combination of source and FEC coding rates suited for the communication channel conditions over which the mobile device 302 is about to communicate. Additionally, the mobile device 302 may use the contextual dependent data to select a particular coding mode of operation of the speech/audio codec. In which a coding mode is selected according to the forthcoming communication channel conditions.

For example, in one operating scenario of embodiments, the contextual data server 320 may receive geographical data that the mobile device 302 has entered into a geographic location in which it is already known that will be significant channel errors. For instance, such locations may include known areas of weak signal reception such as when the mobile device 302 enters a tunnel, or when the mobile device 302 receives a weak signal with many paths of propagation due to being in a built up area. In such instances the contextual dependent data from the contextual data server 320 may be used by the mobile device 302 to select a mode of operation whereby the FEC coding rate would be at a higher rate than if the mobile device was operating over a low error channel. Commensurately in this instance the mobile device 302 would select a lower source coding rate in order to compensate for the higher FEC coding rate.

In other embodiments which deploy a speech/audio codec that is capable of operating at different modes, in other words a multimode speech/audio codec. The above operating scenario, where the contextual data server 320 receives geographical data that the mobile device 302 has entered into a location in which it is known that significant channel error exists, may result in the selection of a source coding mode which may be more robust to channel errors.

In other words, the mobile device 302 may use a priori information relating to forthcoming channel conditions to determine the optimum source and FEC coding rates, or the optimum source coding mode for the said channel.

In embodiments the a priori information may be geographically driven, in other words the a priori information provided by the contextual data server 320 to the mobile device 302 may be tailored to the geographical location of the mobile device 302.

In some embodiments of the mobile device 302 the contextual dependent data provided by the contextual data server 320 may be combined with further contextual dependent data obtained by the mobile device 302. The combination of locally collated contextual dependent data with contextual dependent data from the contextual data server 320 may also be used by the mobile device 302 to select a particular combination or source and FEC coding bit rates, or source coding mode.

In some embodiments the locally collated contextual dependent data for the mobile device 302 may comprise information about direction, speed of travel, altitude and the like.

In further embodiments locally collated contextual dependent data for the mobile device 302 may also comprise measured bit or frame error rates of the wireless channel over which the mobile device 320 is currently communicating.

The contextual data server 320 may be arranged to collate data from further mobile devices which are depicted as mobile devices 302a to 302e in FIG. 3.

The further mobile devices 302a to 302e may also be connected to the contextual data server 320 via a bidirectional wireless data link such as that described above. The further mobile devices 302a to 302e may be arranged to provide contextual dependent data regarding the geographical location or mobile cell they are currently in.

For example, the contextual dependent data generated by the further mobile device 302a may comprise measured frame error rates or bit error rates of the communication channel currently in use. This information may be coupled with location based information such as GPS coordinates, and passed to the contextual data server 320.

In other words the contextual dependent data server 320 may provide the means for receiving contextual dependent data from at least one mobile device, wherein the contextual dependent data comprises at least one communication channel quality measure relating to a geographical location of the at least one mobile device and information relating to the geographical location of the at least one mobile device.

In embodiments the contextual data server 320 may analyse the contextual dependent data from a further mobile device 302a in order to obtain information on the quality of a communication channel with respect to its geographic location.

In other words the contextual data server 320 may analyse the contextual dependent data from each mobile device 302a to 302e in order to build up a database of the quality of communication links for different geographical locations.

For instance, the contextual data server 320 may in embodiments be arranged to process the contextual dependent data in order to identify geographical locations where the communication link may consistently exhibit higher error rates. For example when a mobile device enters into a tunnel, or when a mobile device enters into a location where there is no longer a line of sight with a base station.

Alternatively, the contextual data server 320 may be arranged to process the contextual dependent data provided by the mobile devices 302a to 302e in order to identify geographical locations where the communication link tend to exhibit relatively low error rates.

In embodiments the contextual data server 320 may be arranged to process all the contextual dependent data obtained for a specific geographical location. In some embodiments the processing by the contextual data server 320 may result in an averaged value for the contextual dependent data for a specific geographical location.

In other words the contextual data server 320 may be provided with means for processing contextual dependent data from each mobile device 302a to 302e in order to determine an averaged contextual dependent data for the geographical location of the mobile device 320.

Furthermore, the contextual data server 320 may be provided with means for transmitting the averaged contextual dependent data to the mobile device 302, wherein the transmission of the averaged contextual dependent data is dependent on the mobile device 302 being in the same geographical location of at least one of the mobile devices 302a to 302e.

In some embodiments, a mobile device may not have access to a contextual data server such as the one depicted as 320 in FIG. 3. In these embodiments the mobile device may use contextual dependent data associated with geographical map data stored locally on the device. For instance, the mobile device may measure the bit or frame error rates for a communication channel, and then couple the results of the said measurement with map data in a navigation application.

In other embodiments the contextual data server 320 may be part of the mobile device.

In such embodiments, a mobile device comprising a contextual data server may communicate directly with other mobile devices over the mobile network. The direct communication with other mobile devices may be used to gather information about frame and bit error rate for a communication links currently in use by the other mobile devices. As before this information may also be coupled with geographic information of the other mobile device.

In embodiments where the contextual data server forms part of the mobile device, the contextual data server may also provide a priori information which may be dependent on the geographical location of the mobile device. As before, the a priori information may be used to assist in the choice of source and FEC coding rates.

Furthermore, for embodiments in which the contextual data server forms part of the mobile device, the contextual data server may also be arranged to perform processing functionality as described above in order to analyse the data gathered from other mobile devices.

FIG. 4 shows in further detail a mobile device 302 according to some embodiments. It is to be understood that the functional blocks depicted in FIG. 4 represents a subset of functional blocks which may be found in a mobile device according to embodiments.

In some embodiments the mobile device 302 comprises a receiver 418 of suitable means for receiving.

The mobile device 302 is depicted in FIG. 4 as being arranged to receive a signal on the input 401 via the receiver 418. The output of the receiver 418 is shown as being arranged to be connected to the input of the contextual data analyser 412 via the connection 403.

The step of receiving contextual dependent data by the mobile device 302 is shown as processing step 501 in FIG. 5.

In some embodiments the connection 403 may convey contextual dependent data from a remotely located contextual data server 320. In these embodiments the contextual dependent data as provided by the contextual data server 320 can be passed to the mobile device 302 via the radio signal input connection 401 and the receiver 418.

In other embodiments the connection 403 may convey contextual dependent data from other mobile devices rather than from a contextual data server 320.

In some embodiments, the mobile device 302 comprises a contextual analyser 412 or suitable means for analysing contextual data.

It is to be understood in these embodiments the pre-processing functionality provided by such contextual data server 320 may be performed locally in the mobile device 302 by the contextual data analyser 412. For instance, the contextual data analyser 412 may perform the function of analysing the error rates of various communication links as provided by the other mobile terminals 302a to 302e in relation to their respective geographic locations.

It is to be further understood that the contextual data analyser 412 may have the functionality to formulate an overview of the quality of communication links in relation to their geographic location by collating contextual dependent data from other mobile devices 302a to 392e over a period of time.

In some embodiments the contextual data analyser 412 may be arranged to receive an input signal from a GPS receiver 410 or other suitable means for determining the mobile device's geographical location. It is to be understood that the GPS receiver 410 may be part of the mobile device 302 as depicted in FIG. 4.

In other words the mobile device may have means for determining the current geographical location.

The GPS receiver 410 may be arranged to furnish the contextual data analyser 412 with data relating to the current location, the speed of travel and the direction of travel of the mobile device 302. Parameters of this kind may then be used by the context data analyser 412 in conjunction with the contextual dependent data from either other mobile devices, or a contextual data server 320 in order to assist in the determination of optimum source and FEC coding rates, or an optimum source coding mode.

GPS related data may be conveyed from the GPS receiver to the contextual data analyser 412 along the connection 405.

In embodiments the output of the contextual data analyser 412 may be considered as a priori information relating to the forth coming communication channel.

In other words there may be provided means for processing contextual dependent data to generate a priori information indicative of the quality of a communication channel associated with the current geographical location, wherein the contextual dependent data comprises at least one communication quality measure relating to the current geographical location.

The step of analysing contextual dependent data in order to provide a priori information for the determination of the optimum source and FEC coding rates, or optimum source coding mode is depicted as processing step 503 in FIG. 5.

In some embodiments the mobile device 302 comprises a coding rate/mode selector 414 or suitable means for selecting coding rates and/or coding modes.

In embodiments the output of the contextual data analyser 412 may be arranged to be connected to the input of the coding rate/mode selector 414.

The connection from the contextual data analyser 412 to the coding rate/mode selector 414 is depicted as connection 407 in FIG. 4.

Furthermore, in some embodiments the contextual data analyser 412 may be arranged to have a further output which may be connected to a transmitter 420 in the mobile device 302.

The further output from the contextual data analyser 412 is shown as connection 409 in FIG. 4.

In some embodiments the mobile device 302 comprises a transmitter 420 suitable means for transmitting.

The connection 409 from the context data analyser 412 may be used to convey contextual dependent data relating to the mobile device 302 to the transmitter 420. The contextual dependent data conveyed to the transmitter 420 may comprise components such as the current geographical location of the mobile device 302 and channel frame or bit error rates of the communication link currently used by the mobile device.

In other words the mobile device 302 may provide means for generating contextual dependent data for the current geographical location be measuring the error of the communication channel to determine the communication channel quality measure relating to the geographic location.

The contextual dependent data relating to the mobile device 302 may then be transmitted via the transmitter 420 to any number of other mobile devices such as devices 302a to 302e and/or to a central contextual data server 320.

The coding rate/mode selector 414 may either determine the optimum source and FEC coding rates, or the optimum source coding mode for the forthcoming communication link by using the a priori information furnished by the contextual data analyser 412. In other words the coding rate/mode selector 414 may use the a priori information provided by the contextual data analyser 412 to determine either the source coding rate and FEC coding rate, or the optimum source coding mode. The a priori information may be based at least in part on the geographic location of the mobile device 302.

In further embodiments the coding rate/mode selector 414 may also combine link quality information from the receiver of a receiving mobile device. This information may be sent as an in band signal to the mobile device 320 where it may be used to determine a link quality factor which can provide an indication of the current quality of the communication link. The link quality factor may be combined with the a priori information to provide a coding rate selection which is dependent on both current communication link conditions and forth coming communication link conditions.

In a first group of embodiments the output of the coding rate/mode selector 414 can be a codec rate request signal. The codec rate request signal may be used to request a particular source coding rate in a multi rate speech/audio codec and also a particular FEC coder rate in a FEC coder.

In a second group of embodiments the output of the coding rate/mode selector 414 can be a codec mode request signal. The codec mode request signal can be used to select a particular source coding mode of a multimode audio/speech codec. In some operating instances of the second group of embodiments the codec mode request signal may indicate that the multimode audio/speech codec uses a coding mode which is robust to channel errors. This may be the case when the contextual data analyser 412 has determined that the forth coming channel conditions are likely to have a high rate of channel errors.

It is to be understood in the second group of embodiments in which the coding rate/mode selector delivers a codec mode request signal, the subsequent multimode audio/speech codec may also use FEC coding to add FEC bits to the encoded bit stream.

In other words there may be provided means for determining a codec function signal dependent on the priori information indicative of the quality of the communication channel associated with the current geographical location.

In some embodiments the mobile device 302 comprises a multirate speech/audio encoder 418 or suitable means for encoding multirate speech/audio signals.

The output of the coding rate selector 414 may be connected to both the input of a multi rate speech/audio encoder 418 and to the input of the FEC coder 416.

In other embodiments the output of the coding rate selector 414 may be connected to the input of a multimode speech/audio encoder.

The step of determining the source and FEC coding rates or the source coding mode is depicted as the processing step 505 in FIG. 5.

The multi rate speech/audio encoder 418 takes as an input a digitised speech or audio signal. FIG. 4 depicts the digitised signal input as the input connection 413.

In other embodiments 418 may be a multimode speech/audio encoder or suitable multimode encoding means.

The digitised speech or audio signal may be derived from components such as the microphone 11 and analogue to digital converter 14 shown in FIG. 1 or any suitable means for capturing audio signals.

In a first group of embodiments the digitized signal passed along the input connection 413 may be encoded using a multi rate speech encoder. In this group of embodiments the input digitized speech signal may be encoded on a frame by frame basis by any one of a number of possible source coding rates supported by the multi rate speech encoder 418.

It is to be understood in the first group of embodiments that the coding rate selected for encoding the input speech/audio signal is determined by the coding rate/mode selector 414, and in some embodiments the coding rate selected may vary on a coding frame by coding frame basis.

In an example of a first group of embodiments the multi rate speech/audio encoder may be implemented by incorporating encoding functionality form the 3GPP standard TS.26.090 Adaptive Multi-rate coder (AMR).

In a further example of a first group of embodiments the multi rate speech encoder may be implemented by incorporating encoding functionality from the 3GPP standard TS. 26.191 Wideband Adaptive Multi-rate coder (AMR-WB).

In a second group of embodiments the digitized signal passed along the input connection 413 may be encoded using a multimode speech/audio encoder. In this group of embodiments the input digitized speech or audio signal may be encoded on a frame by frame basis by any one of a number of possible source coding modes supported by the multimode speech/audio encoder 418.

It is to be understood in the second group of embodiments that the coding mode selected for encoding the input speech/audio signal is determined by the coding rate/mode selector 414, and in some embodiments the coding mode selected may vary on a coding frame by coding frame basis.

In other words there may be provided means for encoding an audio signal according to the determined codec function signal, and wherein the codec function signal is indicative of at least one of: a source coding rate; a source coding mode; and a forward error correction coding rate.

The output of the multi rate speech/audio encoder 418 may be a bit stream comprising a parametric representation of the digitised input speech/audio signal.

In some embodiments the mobile device 302 comprises a forward error correction (FEC) coder 416 or suitable means for forward error correction coding.

With reference to FIG. 4, the output of the multi rate speech/audio encoder or multimode speech/audio encoder 418 may be connected to the input of an FEC coder 416.

The step of encoding the input audio or speech signal according to the source coding rate or source coding mode as determined by the coding rate/mode selector is shown as processing step 507 in FIG. 5.

With reference to FIG. 4, the FEC coder 416 takes as an input the speech or audio signal encoded bit stream from the multi rate speech/audio encoder 418. Further, the FEC coder 416 can take as an additional input the coding mode request signal from the coding rate selector 414.

In embodiments the FEC coder may apply FEC coding to each frame of encoded speech/audio signal which is passed from the multi rate speech/audio encoder 416 to the FEC coder 418. In other words the FEC coder 418 may be arranged to code into the bit stream forward error correction bits.

In embodiments the FEC coder 418 can support a number of different FEC coding rates. The rate at which forward error correction is applied to the source encoded bit stream may be determined by the value of the codec mode request signal from the coding rate selector 414.

In a first group of embodiments the FEC coder 418 may apply forward error correction coding to the source encoded bit stream according to the technique of convolutional coding.

The step of adding forward error correction bits to the encoded source signal bit stream is shown as processing step 509 in FIG. 5.

The output of the forward error correction coder, in other words the FEC protected source encoded bit stream, may then be further processed into a format suitable to transmission over a wireless radio link. The processing required may comprise functionality to encapsulate the encoded data into further frames formats and scheduling the transmission through a modulating device.

The functionality and technology required to transmit the encoded data to a particular radio interface standard may be generally depicted in FIG. 4 as the transmitter 420.

Although the above examples describe embodiments of the invention operating within an apparatus 10 which may encompass a mobile device, it would be appreciated that the invention as described above may implement any multi rate audio (or speech) codec, or a multimode audio (or speech) codec including any variable rate/adaptive rate audio (or speech) codec.

Thus user equipment may comprise a multi rate speech/audio codec or a multimode speech/audio codec such as those described in embodiments of the invention above.

In embodiments a geographical location may be referenced by the geographical area of a mobile cell, or the geographical area of part of a part of a mobile cell.

In other embodiments a geographical location may be determined by a satellite navigation system such as GPS, or Galileo Global Satellite navigation system and the like, whereby a geographical location relates to the coordinates of the satellite navigation system. For instance the geographical location may be referenced by the area determined by the GPS coordinates to a defined accuracy.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-45. (canceled)

46. A method comprising:
determining a first geographical location;
processing contextual dependent data to generate a priori information indicative of the quality of a communication channel associated with the first geographical location, wherein the contextual dependent data comprises at least one communication channel quality measure relating to the first geographical location;
determining a codec function signal dependent on the a priori information indicative of the quality of the communication channel associated with the first geographical location; and
encoding an audio signal according to the determined codec function signal.

47. The method as claimed in claim 46, wherein the codec function signal is indicative of at least one of:
a source coding rate;
a source coding mode; and
a forward error correction coding rate.

48. The method as claimed in claim 46, further comprising at least one of:
receiving the contextual dependent data from a contextual dependent data server; and
receiving the contextual dependent data from a mobile device.

49. The method as claimed in claim 46, further comprising:
generating contextual dependent data for the first geographical location by measuring the error of the at least one communication channel to determine the at least one communication channel quality measure relating to the first geographic location.

50. The method as claimed in claim 46, wherein the at least one communication channel quality measure is at least one of:
a bit error rate of the at least one communication channel; and
a frame error rate of the at least one communication channel.

51. The method as claimed in claim 49 further comprising:
transmitting the contextual dependent data to at least one of:
a mobile device; and
the contextual dependent data server.

52. The method as claimed in claim 47, wherein the coding function signal indicates at least one of:
source coding mode the audio signal is encoded using a multimode audio codec; and
source coding rate the audio signal is encoded using a multi rate audio codec.

53. The method as claimed in claim 46, wherein the first geographical location is in the form of global positioning system coordinates.

54. A method comprising:
receiving contextual dependent data from at least one mobile device, wherein the contextual dependent data comprises at least one communication channel quality measure relating to a geographical location of the at least one mobile device and information relating to the geographical location of the at least one mobile device;
processing contextual dependent data from the at least one mobile device to determine an averaged contextual dependent data for the geographical location; and
transmitting the averaged contextual dependent data from the at least one mobile device to a further mobile device, wherein the transmission of the averaged contextual dependent data is dependent on the further mobile device being in the geographical location.

55. The method as claimed in claim 54 further comprising:
receiving data from the further mobile device, wherein the received data indicates that the further mobile device is in the geographical location.

56. The method as claimed in claim 54, wherein the geographical location is in the form of global positioning system coordinates.

57. An apparatus comprising at least one processor and at least one memory including computer code for one or more programs, the at least one memory and the computer code configured to with the at least one processor cause the apparatus to:
determine a first geographical location;
process contextual dependent data to generate a priori information indicative of the quality of a communication channel associated with the first geographical location, wherein the contextual dependent data comprises at least one communication channel quality measure relating to the first geographical location;
determine a codec function signal dependent on the a priori information indicative of the quality of the communication channel associated with the first geographical location; and
encode an audio signal according to the determined codec function signal.

58. The apparatus as claimed in claim 57, wherein the codec function signal is indicative of at least one of:
a source coding rate;
a source coding mode; and
a forward error correction coding rate.

59. The apparatus as claimed in claim 57, wherein the at least one memory and the computer code configured with the at least one processor further cause the apparatus to at least one of:
receive the contextual dependent data from a contextual dependent data server; and
receive the contextual dependent data from a mobile device.

60. The apparatus as claimed in claim 57, wherein the apparatus is further caused to:
generate contextual dependent data for the first geographical location by measuring the error of the at least one communication channel to determine the at least one communication channel quality measure relating to the first geographic location.

61. The apparatus as claimed in claim 57, wherein the at least one communication channel quality measure is at least one of:
a bit error rate of the at least one communication channel; and
a frame error rate of the at least one communication channel.

62. The apparatus as claimed in claim 60, wherein the apparatus is further caused to:
transmit the contextual dependent data to at least one of:
a mobile device; and
the contextual dependent data server.

63. The apparatus as claimed in claim 58, wherein the coding function signal indicates at least one of:
a source coding mode the audio signal is encoded using a multimode audio codec; and
a source coding rate the audio signal is encoded using a multi rate audio codec.

64. The apparatus as claimed in claim 57, wherein the first geographical location is in the form of global positioning system coordinates.

65. An apparatus comprising at least one processor and at least one memory including computer code for one or more programs, the at least one memory and the computer code configured to with the at least one processor cause the apparatus to:
receive contextual dependent data from at least one mobile device, wherein the contextual dependent data comprises at least one communication channel quality measure relating to a geographical location of the at least one mobile device and information relating to the geographical location of the at least one mobile device;
process contextual dependent data from the at least one mobile device to determine an averaged contextual dependent data for the geographical location; and
transmit the averaged contextual dependent data from the at least one mobile device to a further mobile device, wherein the transmission of the averaged contextual dependent data is dependent on the further mobile device being in the geographical location.

66. The apparatus as claimed in claim 65, wherein in the apparatus is further caused to:
receive data from the further mobile device, wherein the received data indicates that the further mobile device is in the geographical location.

67. The apparatus as claimed in claim 65, wherein the geographical location is in the form of global positioning system coordinates.
